(19) United States
(12) Patent Application Publication
(10) Pub. No.: US 2008/0122226 A1
(43) Pub. Date: May 29, 2008

(54) Compact assemblies for high efficiency performance of cryogenic liquefied gas expanders and pumps

(75) Inventor: Joel V. Madison, Reno, NV (US)

Correspondence Address: EDWARD J. DARIN, INC., 301 EAST COLORADO BLVD, SUITE 518, PASADENA, CA, 91101, US

(73) Assignee: EBARA International Corporation

(21) Appl. No.: 11/985,632

(22) Filed: Nov. 16, 2007

Related U.S. Application Data
(60) Provisional application No. 60/861,841, filed on Nov. 29, 2006.

(51) Int. Cl. F01D 15/10; F01D 25/08; F03B 13/00

(52) U.S. Cl. 290/52; 415/180

(57) ABSTRACT

A compact assembly of a liquefied natural gas, (LNG)-mixed hydrocarbon refrigerants, (MR), arranged on a single shaft assembly for individual expanding the LNG and MR streams including sealing means for separating and isolating the processing of a LNG stream and MR stream at a pre-selected location intermediate the ends of the single shaft assembly. The liquefied natural gas, LNG, stream is coupled to a hydraulic turbine expander mounted on the single shaft assembly adjacent a first end thereof. The hydraulic turbine expander has two phase expansion capabilities. The hydraulic expander is enclosed in a vessel mounted between one end of the sealing means and beyond the first end of the shaft assembly for isolating the expander. The LNG stream and the vessel are arranged to traverse a pre-selected path within the vessel. The compact assembly may include a induction motor means mounted to the shaft assembly adjacent the sealing means. At least a single MR hydraulic turbine expander mounted to the single shaft assembly adjacent a second end of the shaft assembly. Each of the hydraulic turbine expanders having runner means mounted to the shaft assembly to be rotatably responsive to the fluid streams coupled thereto for rotating the shaft assembly and thereby the induction motor means functioning as an electrical power generator. The remaining portion of the shaft assembly is enclosed in a MR vessel for isolating the MR expander and the second end of the shaft assembly. The MR vessel is designed to have a MR inlet and outlet for causing the MR stream to follow a path in the opposite direction from the LNG stream to offset the thrust forces generated by the hydraulic turbine. The thrust forces can be offset without the need for an individual thrust equalizing mechanism.

### RELATED APPLICATION

Priority is claimed on the basis of the Provisional Application bearing Ser. No. 60/861,841, filed on Nov. 29, 2006 and entitled Compact Assembly Configuration for high-efficiency performance of cryogenic liquefied gas expanders and Pumps.

The present invention relates to compact assemblies for cryogenic liquefied gas in a two phase Turbine Expander and more particularly to a hydraulic turbine expander for a cryogenic, liquefied Natural Gas, LNG, for processing the gas in two phases, liquid and vapor phases.

### BACKGROUND OF INVENTION

The subject matter of the aforementioned Provisional Application is expanded by the Applicant's publication entitled “Compact Liquefied Gas Expander Technological Advances”.

This publication by the Applicant, Joel V. Madison, was made publicly available by Mr. Madison's presentation at the Sixth World LNG Summit in Rome, Italy on Nov. 30, 2005. The entire Madison publication is incorporated herein, in its entirety, by references.

Liquefied Natural Gas, LNG, turbine expanders are now an important part of every new LNG liquefaction plant. The turbine expanders are applied in single phase duties to enhance the performances of the LNG liquefiers. A brief history of LNG liquefaction plants and the use of two phase liquid and gas/vapor streams as discussed in the publication entitled. “Two-Phase LNG Expanders” published by the Gas Processors Association-GTL and LNG in Europe at Amsterdam on Feb. 24-25, 2005. This publication essentially represents the state of the art as to LNG liquefiers and two phase submerged turbine expanders for processing cryogenic liquids. This publication discusses the EBARA turbine expanders and the EBARA Two Phase Hydraulic Assembly with the two phase cryogenic submerged turbine expander along with the two phase jet exducer as illustrated and described in conjunction with FIGS. 4 and 5, all of the publication is incorporated herein by reference.

The EBARA two phase expander is also disclosed in the publication of the 14^{th} International Conference and Exhibition on Liquefied Natural Gas held in Doha, Quatar on Mar. 21-25, 2004.

The EBARA U.S. Pat. No. 5,659,205 is relevant as to the solution of the thrust forces generated in hydraulic turbine by means of the thrust equalizing mechanism, TEM, as disclosed and claimed in said patent. The thrust equalizing mechanism is disclosed and illustrated in detail with regard to FIGS. 2 and 3 of the patent as applied to a hydraulic turbine and which patent disclosure is incorporated herein by reference.

### BRIEF SUMMARY OF INVENTION

The present invention provides improved, compact assemblies for high efficiency performance of cryogenic, liquefied gas expanders and pumps. The improvements disclosed herein allow for significant increases in process efficiency and substantial reductions in the physical size and complexity of liquefaction plants. These improvements are important for all new and existing plants and are especially important for applications in which space is limited or critical, such as offshore liquefaction facilities. Retrofitting of existing liquefaction plants based on older technology also benefit as lower production costs will enable such plants to remain competitive with new installations currently operating or under construction.

The basic assembly of the compact assemblies comprising a single shaft assembly having at least a single cryogenic liquefied natural gas, LNG, turbine expander mounted thereon and a mixed refrigerant, MR, hydraulic turbine expander mounted on the single shaft assembly with sealing means mounted to the shaft separating the LNG and MR steams from one another. The mixed refrigerant is used in the liquefaction process. The shaft also mounts a common electrical power generator that is cooled by the liquid stream which has the least impact on the process efficiency, preferably the MR stream. The thrust forces of the turbine are minimized in this configuration by arranging the LNG and MR streams to flow in opposite directions to minimize the effect of thrust loading resulting in improved higher hydraulic efficiencies. The hydraulic turbine expander for the LNG stream is preferably capable of processing both the liquid stream and a combination liquid and vapor stream.

A further modification of the aforementioned basic assembly is the separation of an inert fluid stream for cooling the power generator. This requires additional sealing means for isolating the individual LNG, MR streams and coolant streams from one another. The inert cooling stream can be liquefied nitrogen or liquefied petroleum gas for cooling the power generator. To increase the overall efficiency it is preferable that the coolant stream be introduced into the generator section at a higher pressure than the pressures of the LNG and MR streams for off-setting the thrust forces along with the opposite flow directions of the LNG and MR streams whereby the highest overall efficiency results.

A further improved assembly comprises a single shaft assembly comprising at least a single turbine expander for either a LNG or MR stream in combination with an induction generator capable of functioning as either a motor or power generator or under no load along with a fluid pump. As in the basic assembly hereinabove single sealing means separates the turbine gas expander from the induction motor/generator and pumping means. The use of the induction motor/generator to drive the fluid pump increases the electrical efficiency. The pumped fluid is used to cool the induction motor/generator. The flow paths in the isolated sections of the assembly are in the opposite directions for minimizing the thrust loading.

As described hereinabove, this later assembly may be improved by separating the coolant stream for the induction motor/generator from the expander fluids and the pumping means by the addition of further sealing means on the single shaft assembly as described hereinabove. The coolant stream is preferably introduced at a higher input pressure than the fluid coupled to the turbine expander and the fluid to be pumped for minimizing the thrust loading along with opposite flow directions. This assembly configuration provides the highest overall efficiency as no process fluid is used for cooling purposes or thrust balancing.

### BRIEF DESCRIPTION OF THE DRAWINGS

These and other features of the present invention may be more fully appreciated when considered in the light of the following specification and drawings, in which:

FIG. 1 is a cross-sectional view of a compact assembly of a LNG hydraulic turbine expander and MR turbine expander with the induction generator and MR expander being arranged on the single shaft in an isolated arrangement with the LNG expander whereby the induction generator is cooled by the fluid flow from the MR expander and the fluid flow paths for the entire assembly are illustrated;

FIG. 2 is a cross-sectional view of the compact assembly of FIG. 1 but illustrating the induction generator cooled by an individual coolant stream and isolated from both of the expanders and their respective fluid paths, as illustrated therein.

FIG. 3 is a cross sectional view of a compact assembly similar to FIG. 1 except that fluid pumping means is substituted for the MR expander and the pumped fluid functioning to cool the induction generator, and

FIG. 4 is a cross-sectional view of a compact assembly similar to FIG. 3 except the induction generator is illustrated isolated from both the hydraulic turbine gas expander and the fluid pumping means and is cooled by an individual coolant as in the FIG. 2 embodiment of the compact assembly.

### DETAILED DESCRIPTION OF THE EMBODIMENTS OF THE INVENTION

Now referring to the drawings, the hydraulic turbine expanders, both the LNG and MR expanders are characterized as submerged hydraulic turbine expanders to be operative in response to pre-selected hydraulic fluids coupled to the turbines. It should be noted, at the onset, that the terms “hydraulic fluids” or “hydraulic fluid flow” as utilized in the present invention is an operative hydraulic fluid useful for operating the hydraulic turbine and when used for cooling purposes is an electrically non-conductive fluid including cryogenic liquefied natural gas, liquefied methane gas, liquefied ethylene gas, liquefied petroleum gas and similar liquefied hydrocarbons. The source of hydraulic fluid provides the selected hydraulic fluid at a varying or constant pressure and velocity such as may be obtained from wells, etc.

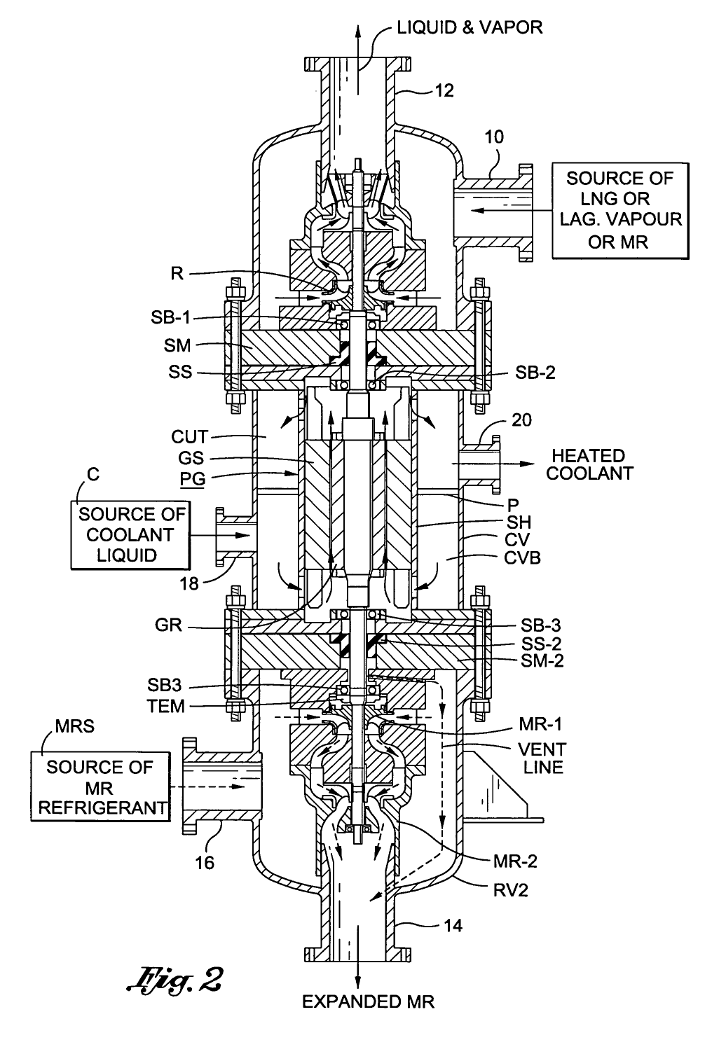

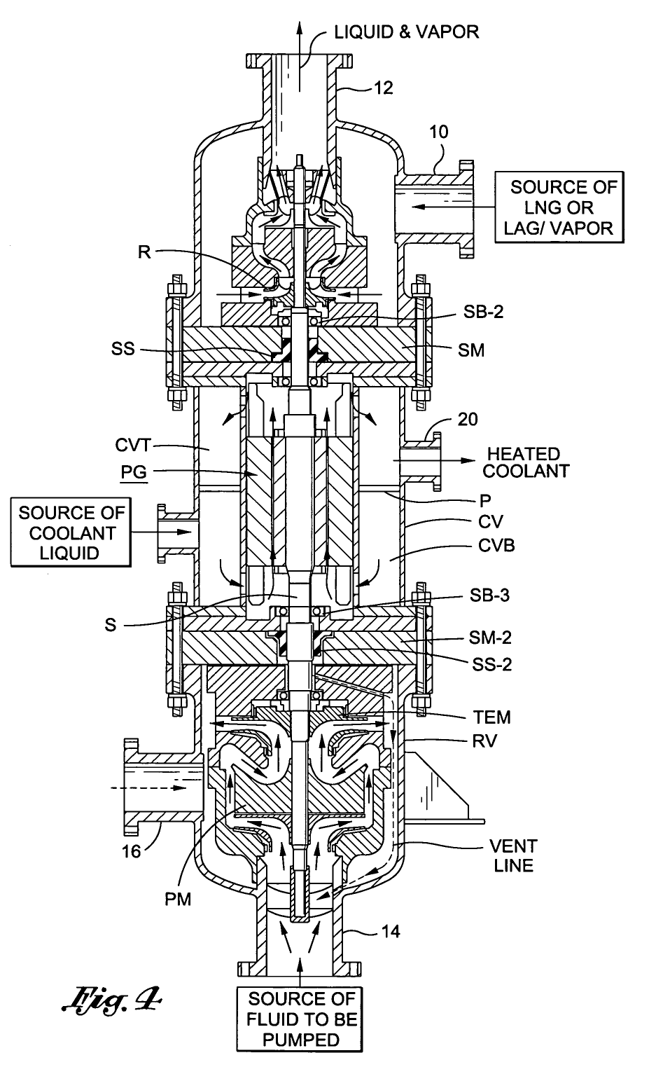

The hydraulic turbine expanders utilized in the illustrated compact assemblies are the EBARA International Corporation's expanders described and illustrated in the publication entitled “Two-Phase LNG Expanders” published by the Gas Processors Association at Amsterdam on Feb. 24-25, 2005 referenced hereinabove and incorporated herein by reference. FIG. 4 of this publication illustrates the EBARA cryogenic two phase submerged expander in cross-section with FIG. 5 illustrating the two phase hydraulic assembly comprising a nozzle ring for generating the rotational fluid flow for impingement on the radial flow reaction turbine runner along with a two phase jet exducer. As illustrated in the drawings it includes a thrust balancing device arranged for turbine use as disclosed and claimed in the EBARA U.S. Pat. No. 5,659,205 and described with respect to FIG. 2 thereof and is incorporated herein by reference.

As the aforementioned publication entitled “Two Phase LNG Expanders” makes clear the art has advanced beyond the use of Joule-Thomson (J-T) valves for pressure reduction or expansion to hydraulic turbine expanders. Expansion turbines are more efficient since they carry out isentropic depressurization which generates work instead of isenthalpic depressurization across a J-T valve, which generates no work. Turbines take energy out of the process bringing about greater cooling of the streams passing through them and thereby increase overall process efficiency. In simple terms cooling of the liquid stream due to expansion of the liquid is utilized for the liquefaction of gases.

The compact assemblies disclosed herein basically function as single-phase turbines and expander technology having horizontal rotational axis but differ by utilizing a vertical rotational axis to stabilize flow and to minimize flow induced vibrations. The direction of the liquid flow is upward as is evident from the drawings, to take advantage of the buoyant forces of the vapor bubbles. The hydraulic energy of the pressurized fluid is converted by first transforming it into Kinectic energy, then into mechanical shaft power and finally to electrical energy by means of an electrical power generator. Basically the electrical generator is located adjacent the expander on a single shaft assembly to be rotated by the turbine in response to the liquid flows impinging thereon as will be evident hereinafter.

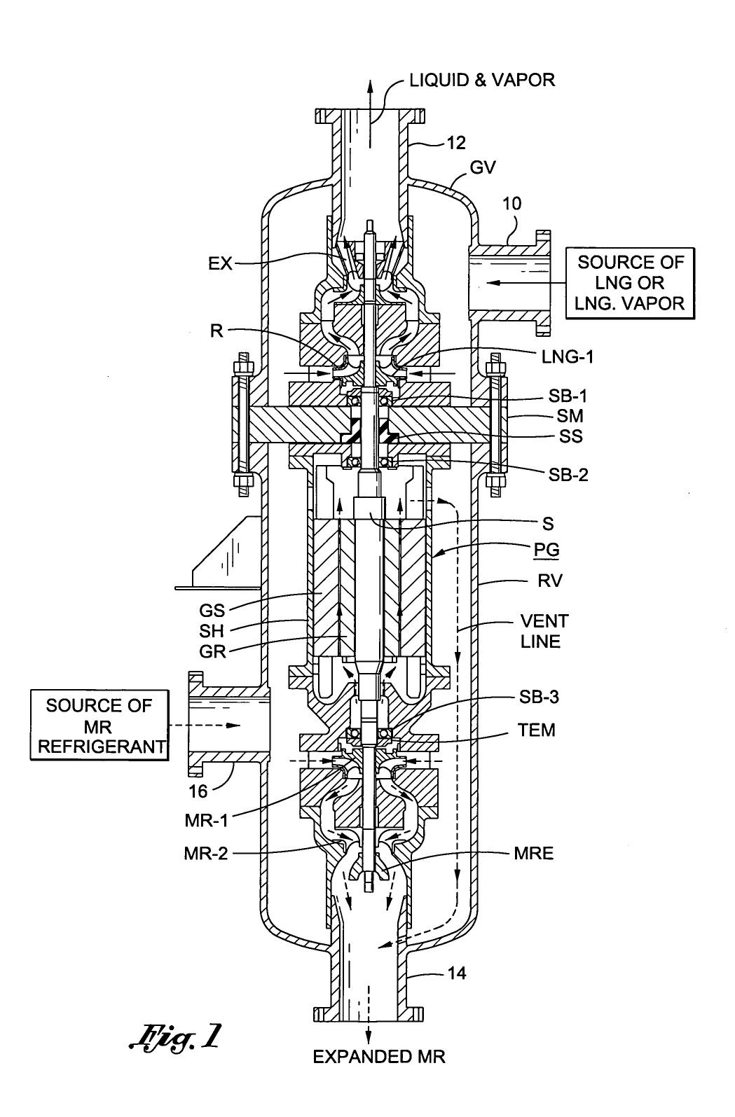

Now referring specifically to FIG. 1, the basic compact assembly configuration will be examined in detail. The compact design utilizes a single shaft assembly S for mounting at least a single LNG expander LNG-1 mounted adjacent one end of the single shaft S within a LNG vessel GV having an inlet 10 and an outlet 12 arranged to cause the liquefied gas to have a flow path that is clockwise in the vessel GV and through the expanded LNG-1 and LNG-2. the input fluid is coupled to the radial inflow reaction turbine runner R wherein the static pressure energy of the input fluid is converted into rotational energy that rotates the shaft (S) thereby reducing the pressure of the input fluid. At the exit of the runner T, the expander is designed so the pressure of the fluid reaches the saturated point and partially vaporizes the fluid. The fluid discharged from the runner R enters a two phase exducer Ex that further vaporizes the input liquid. At the exit of the fluid from the exducer Ex the two phase fluid reaches a high exit velocity forming a jet-like fluid stream from the exducer Ex. The jet-like fluid stream exerts a reaction force on the exducer Ex causing additional torque to be generated whereby the power extracted from the fluid is increased significantly due to this additional expander step of the fluid. The drawing FIG. 1 illustrates 2 stages of LNG expanders for two phase expansion of the LNG introduced into the vessel GV. The vessel GV has one end, the bottom end as illustrated in FIG. 1 sealed off by the provision of sealing means SM provided with a shaft seal SS at a section of the shaft S that is reduced in diameter adjacent a shaft bearing SB-1 mounted inside the vessel GV. It is understood that in the use of multiple expander stages, the output of one expander is coupled to the serially arranged expander stage. As Illustrated, then, the fluid discharged from turbine expander LNG-1 is coupled to the runner R for the turbine expander LNG-2 and successive stages, if more than two are utilized. The fluid discharged from the last of the expander stages is coupled directly to the exducer Ex and is discharged as two phase liquid stream.

The remaining portion of the compact assembly on the single shaft S is for processing the multiple refrigerants, MR mounted within the vessel RV. The open end of the vessel RV is mounted to the opposite side of the sealing means SM whereby the two vessels GV and RV are bolted to extensions of the vessels that protrude outwardly as illustrated. The vessel RV encloses the remaining portion of the single shaft S mounted between bearing SB-2 and the bottom bearing SB-3. The mixed refrigerant MR is a mixture of many hydrocarbon fluids that mostly contains methane. The MR stream is used as a refrigerant in the liquefaction process and is arranged in closed loop while the LNG stream is constantly being pumped out of the liquefaction plant. The mixed multiple refrigerants are utilized in lieu of commercial refrigerants because it is normally available in the plant, inexpensive and the thermodynamic properties can be adjusted with the composition to provide the desired heat transfer. It will be recognized by those skilled in the art that the processing of the mixed refrigerant MR can be accomplished by either single phase liquid processing or multiple phases and the hydraulic turbine expander may be either a single stage or multiple stages. As illustrated in FIG. 1 a two stage expander is shown, namely, MR-1 and MR-2 arranged adjacent the bottom of the shaft S to be discharged from the vessel RV outlet 14. The vessel RV is also provided with a fluid outlet 16 arranged intermediate the ends of the vessel for coupling the MR fluid stream to the runner for expander MR-1. The fluid inlet 16 is illustrated on the left hand side of vessel RV coupled to the block MRS identified as the source of the mixed refrigerant and arranged for coupling the refrigerant to the runner of expander MR-1. The outlet 14 for the vessel receiving the expanded fluid expander MR-2 beyond the bottom end of the shaft S after passing through the exducer MRE. This MR stream flows in the vessel RV in the opposite direction from the flow of the LNG stream in vessel GV.

The remaining portion of the shaft S moun an electrical power generator PG that is characterized as being submerged or isolated within a housing SH. The power generator PG is mounted immediately adjacent the shaft bearing SB-2 mounted to the shaft immediately below the sealing means SM. The generator PG may be an induction generator that has a generator rotor GR mounted to the shaft S to be rotatable therewith at the speed imported to the shaft by the hydraulic turbines. The stator winding GS are electrically excited and are mounted in a spaced relationship around the rotor GR. The electrical power generated by the generator PG at the rotor GR is available outside of the vessel RV at the power cables (not shown), all as well known in the art. The lower end of the shaft S that extends beyond the housing SH is supported by the lower bearing SB-3. The operative fluid applied to the refrigerant turbine MR-1 is conveyed into the housing SH and lubricates the bearings and cools the power generator PG. It will be noted that this configuration of the submerged power generator separates the heat at the generator from the LNG stream which results in improved process efficiency.

The reaction turbines are known to generate relatively high axial thrust resulting in heavy bearing loads that reduce the efficiency due to friction losses. The drawing illustrates the thrust equalizing mechanism TEM arranged with the turbine radial runner and the thrust bearing SB-3 disclosed in detail in U.S. Pat. No. 5,659,205. The thrust balancing results by providing small axial, bi-directional movements to the single shafts for offsetting the thrust forces created whereby the balancing of the generated thrust forces occur gradually and smoothly with the continuous bi-directional, alternate axial movements of the shaft assembly. Conduit means represented in dotted lines running between the upper end of the housing SH to adjacent the fluid discharge side at vessel outlet 14 is required.

Although the thrust equalizing mechanism TEM is illustrated I the drawing the opposite fluid flows of the liquid streams in vessels GV and RV are designed for minimizing or eliminating the thrust forces without the need of the mechanism TEM. When it is desired to utilize the thrust balancing mechanism TEM it may be located with either the MR Expander (as illustrated) or with the LNG Expander or in both locations. It is preferable that the TEM be located as shown in FIG. 1. With the combination of the opposite flow directions of the operative streams, the thrust forces generated oppose one another. This results in higher hydraulic efficiency since less of the operative fluid is required for the operation of the TEM mechanism to offset the generated thrust forces. It should now be appreciated that the compact arrangement of combining the LNG and the MR expander on the single shaft results in savings in cost, space and complexity.

Now referring to FIG. 2, the improved compact assembly illustrated therein will be examined. The basic difference with the assembly of FIG. 1 is that in FIG. 2 the power generator PG is completely isolated from both the LNG stream and the MR steam and a second sealing means SM-2 having shaft seal SS-2 is utilized between the means for processing of the MR stream and the electrical power generator as illustrated. The heat generated at the power generator PG is dissipated by the introduction of an individual, inert cooling stream such as liquid nitrogen or liquid propane. To accommodate the aforementioned changes the vessel RV is modified and comprises the cooling vessel CV for enclosing and isolating the submerged power generator PG in the housing SH. The vessel CV has an inlet 18 coupled to a source of a liquid coolant C and an outlet 20 for discharging the heated coolant liquid after it has traversed a counter-clockwise path through the vessel CV and generator PG to the outlet 20. The top of the vessel CV is sealed off and secured to the bottom side of the sealing means SM for the LNG processing. The interior of the vessel CV is divided into two sections CVT and CVB by means of the partition P. The top section CVT is divided immediately below the coolant outlet 20 and the bottom section CVB is above the inlet 18 to cause the coolant liquid to move downwardly and into the aperture housing SH and upwardly through the generator PG and outwardly of the aperture top of the housing SH into the volume CVT and out the outlet 20 as illustrated in FIG. 2.

The bottom side of the sealing means SS-2 seals off the top of the MR vessel RV-2. The structure for expanding the MR stream is the same as the structure of FIG. 1 for processing the mixed refrigerant introduced therein at inlet 16 and taking a clockwise path through the expanders MR-1 and MR-2 to the outlet 14. This includes the thrust equalizing device TEM and the bearing SB-3. The vent line (not shown) is located by the dotted line connected above the bearing SB-3 and to the discharge end of outlet 14. The sealing means SS-2 is bolted between the vessels CV and RV-2 as illustrated. The thrust balancing device is illustrated in FIG. 2 (as in FIG. 1) in the MR processing vessel RV2. The mechanism TEM may also be located with the LNG expander or in both the LNG and MR expander. The thrust balancing device is preferably arranged within the coolant vessel CV. As in the previous embodiment, the generated thrust is minimized by the opposite flow direction of the liquid under-going processing. This compact combination, then, is advantageous since no heat is transferred to either the LNG stream or the MR stream so as to have an increased process efficiency. In the preferred arrangement of thrust balancing no process fluid is utilized to offset the generated thrust forces resulting in higher hydraulic efficiency. The coolant liquid can be coupled into the vessel CV at a pressure that is greater than the inlet pressure for the LNG or MR stream and due to the opposite flow patterns offset the generated thrust.

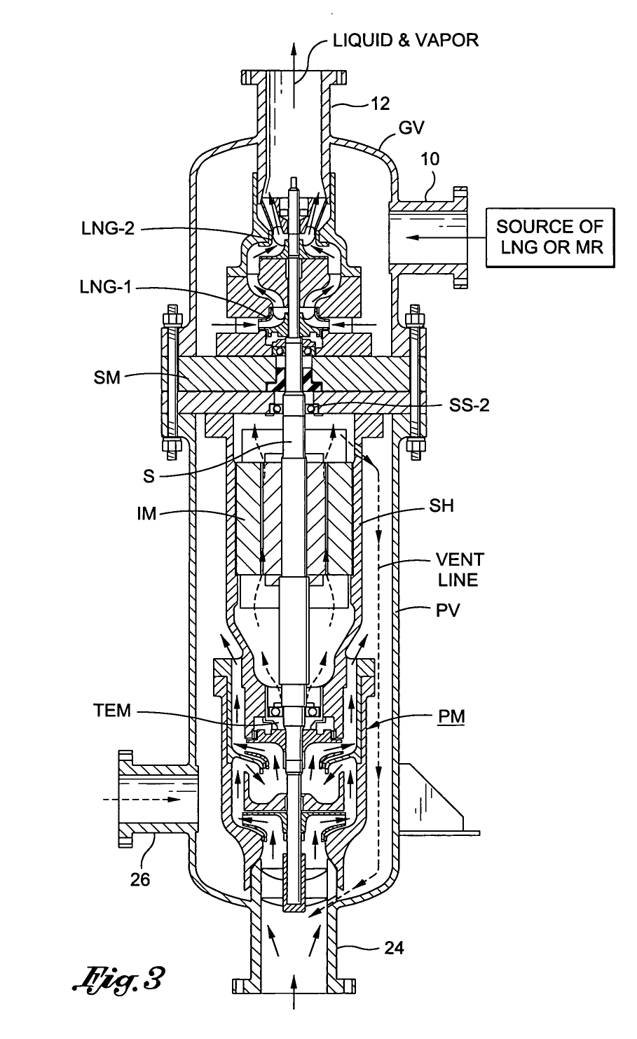

Now referring to FIG. 3, the compact assembly of a fluid expander and pumping means on the single shaft assembly S will be described. The basic arrangement for processing the liquid stream at the top end of the shaft S, as illustrated, is the same as in FIG. 1 except the liquid stream can be the LNG or the mixed refrigerant MR with two stages of expansion and capable of two phase processing.

The power generator illustrated in FIG. 3 can be an induction motor/generator IM. The induction motor IM can be controlled to function as a power generator or as a motor or under no load conditions as is well known in the art. The bottom portion of the shaft assembly carries fluid pumping means PM in lieu of the hydraulic turbine expander for the MR stream of FIG. 1. The vessel PV therefore houses the pumping means PM and the submerged induction motor IM. The vessel PV has an inlet 24 for the fluid to be pumped and an outlet 26. The pump PM includes a thrust equalizing mechanism TEM of the type described in U.S. Pat. No. 5,659,205 for the pump. The pumped liquid flows upwardly for the vertically arranged shaft assembly S for cooling the induction motor IM. It is preferable the thrust equalizing mechanism be located in the pumping means PM as illustrated. The mechanism TEM may be in the liquid expander or in both locations. The advantage of the compact assembly of FIG. 3 is no heat is transferred to the liquid stream being expanded resulting in improved process efficiency and the fluid to be expanded is not utilized in the thrust balancing mechanism. The thrust is minimized by the opposite flow configuration. The vent line location is illustrated in dotted outline and runs from the fluid discharge end of the induction motor IM to the opposite end of the vessel PV at the pump inlet stream.

Now referring to FIG. 4, the embodiment of FIG. 3 is further modified to isolate the induction motor IM and cooled by an individual coolant stream in the manner disclosed in FIG. 2.

The coolant vessel CV is utilized in the embodiment of FIG. 4 along with the vessel RV for housing the pumping means PM along with the second sealing means SM-2 and the shaft seal SS-2. As in FIG. 2, the structure for cooling the induction motor IM is separated from both the gas expanders and the pumping means without transferring heat. The inert cooling stream is introduced into the vessel CV of FIG. 4 at a higher input pressure than the input pressure for the fluid streams to be expanded to balance the generated thrust forces. Also, as in FIG. 2, the induction motor IM is operated as a electrical motor so as to drive the fluid pumping means PM whereby the electrical efficiency is increased by so powering the pumping means.

As to the balancing the generated thrust forces, it is preferable that a thrust balancing device of the type of U.S. Pat. No. 5,659,205 be utilized in the inert coolant stream to balance out the residual thrust forces remaining in the combination after minimization by the opposite flow paths. It can also be accomplished by locating a thrust balancing device in association with the pumping means PM or in both the pumping means PM and the gas expander. Improved process efficiency is experienced due to process liquid is not being used to balance the thrust forces.

The embodiments of FIGS. 2 and 4 are best suited for gas liquefaction plants that have nitrogen and propane readily available for cooling purposes.

It should now be appreciated that the above described compact assemblies can be useful for any combinations of process fluids, LNG-HMR, Ammonia, MR-Ethane, LNG-Ethane, Ethane-Ethylene, etc. This then covers all process types for the improved compact assemblies.

1) A compact assembly of a liquefied natural gas, (LNG)-mixed hydrocarbon refrigerants (MR), for individually expanding the LNG and MR streams comprising
a single shaft assembly having first and second ends for mounting a hydraulic turbine expansion means and electrical power generating means thereon between said ends, said shaft assembly being oriented in a substantially upward direction,
sealing means mounted to said single shaft assembly for separating the processing of the LNG and MR streams at a pre-selected location intermediate the ends of said single shaft assembly,
a hydraulic turbine expander mounted to said shaft assembly adjacent said first end thereof, said turbine expander having two phase expansion capabilities,
a vessel having a liquefied gas inlet and expanded gas outlet mounted between said sealing means and beyond said first end of said single shaft assembly for isolating said turbine expander,
an induction motor means mounted to said shaft assembly adjacent said sealing means,
at least a single, MR hydraulic turbine expanding means mounted to said shaft assembly adjacent said second end of said shaft assembly,
each of said turbine expanding means having runner means mounted to said shaft assembly to be rotatably responsive to fluid streams impinging thereon for rotating said shaft assembly and thereby said induction motor means,
a MR vessel having a mixed refrigerant inlet and outlet for coupling a MR stream to said MR expanding means and isolating and housing the second end of said shaft assembly and said motor means to said sealing means,
said induction motor means function as an electrical power generator and arranged to receive the MR stream discharged from said MR expanding means to thereby cool said power generators.

2) A compact assembly as defined in claim 1 wherein said hydraulic turbine expander mounted adjacent said first end of said shaft assembly comprises a plurality of hydraulic turbine expanders having two phase capabilities.

3) A compact assembly of a LNG Expander and MR Expander comprising
a single shaft assembly having first and second ends for mounting at least a single, two phase submerged LNG turbine expander and at least a single phase submerged MR turbine expander arranged on said shaft assembly in a spaced apart relationship on said shaft assembly between said first and second ends,
sealing means mounted to said shaft assembly between said submerged turbine expanders to thereby isolate said expanders from one another,
an electrical power generator mounted on said shaft assembly adjacent said MR turbine expander,
a mixed refrigerant vessel mounted between said sealing means and a first end of said single shaft assembly for isolating said submerged turbine expander and said electrical power generator, said refrigerant vessel having a MR inlet and outlet for coupling said MR refrigerant into said refrigerant vessel to flow into said refrigerant turbine expander and through said power generator for cooling said generator and through the MR vessel outlet, and
a LNG vessel mounted between said sealing means and a second end of said single shaft assembly for isolating said two phase turbine expander and having a vessel outlet and inlet for receiving a fluid stream of LNG or a mixture of a LNG fluid and vapor for coupling said stream to said turbine expander and moving upwardly to said vessel outlet,
the inlets and outlets for the LNG vessel and the MR vessel are arranged to cause the fluid streams coupled thereto to move within their respective vessels in opposite directions between the individual inlet and outlet and thereby minimizing the thrust forces generated by the turbine expanders.

4) A compact assembly of a LNG Expander and MR Expander as defined in claim 3 including thrust equalizing means mounted to said shaft assembly within said refrigerant vessel for balancing out the thrust forces in combination with the opposed fluid flows in the LNG and refrigerant vessels.

5) A compact assembly of a LNG Expander and MR Expander as defined in claim 3 wherein said single shaft assembly is oriented in an upward direction to cause the fluids applied to said shaft assembly to travel upwardly.

6) A compact assembly of a LNG Expander and MR Expander as defined in claim 4 or 5 wherein said LNG turbine expander comprises a plurality of expanding stages, each stage comprising two phase expanders.

7) A compact assembly of a liquefied natural gas, LNG, mixed hydrocarbon refrigerants, MR, comprising
a single shaft assembly having first and second ends,
first and second sealing means mounted on the shaft assembly in a pre-selected spaced relationship thereon,
a gas vessel having a gas inlet and gas outlet for coupling a LNG stream comprising a liquefied LNG stream or a LNG vapor stream to traverse the gas vessel in a pre-selected direction between the inlet and outlet through the vessel and thereby isolating and housing the first end of the shaft assembly at the first sealing means,
at least a single, two phase LNG hydraulic turbine expander mounted to said shaft assembly adjacent said first end of the shaft assembly and traversed by the LNG stream in its path between the gas vessel inlet and outlet,
a MR vessel having a refrigerant inlet and outlet for coupling a MR steam to traverse the MR vessel in a pre-selected direction through the vessel and isolating and housing the second end of the shaft assembly to the second sealing means,
at least a single MR turbine expander mounted to the shaft assembly adjacent the second end of the shaft assembly and traversed by the MR stream in a preselected direction, opposite the direction of the LNG steam in its path between the inlet and outlet for the MR vessel, the turbine expander having a radial turbine runner means mounted to said shaft assembly to be rotatably responsive to said inlet gas stream coupled thereto for rotating said shaft,
an electrical power generator mounted on the shaft assembly between the first and second sealing means and rotatably responsive to the rotary movements imparted to said shaft upon the operation of said turbine means and in accordance with the speed thereof,
a coolant vessel mounted between said first and second sealing means and having a coolant inlet and coolant outlet for introducing an inert coolant fluid stream into the coolant vessel for cooling the electrical power generator in its path between the coolant inlet and outlet, the inert coolant stream being under a higher input pressure than the LNG and MR stream for balancing the thrust forces generated by the LNG hydraulic and MR hydraulic expanders including due to the opposite flow directions of LNG and MR streams whereby the heat generated by said power generator is completely separated from the LNG stream and MR stream resulting in a higher efficient compact LNG-MR Expander.

8) A compact assembly of a hydraulic turbine expander and pump with an induction motor/generator comprising
a single shaft assembly having first and second ends,
sealing means mounted to said shaft assembly for separating the processing and expansion of a liquid stream at a pre-selected location intermediate said ends of the shaft assembly and spaced a pre-selected distance from a first end of said shaft assembly,
a hydraulic turbine expanding means mounted to said shaft assembly adjacent said first end thereof,
an inlet vessel for said turbine expanding means connected between said sealing means and beyond said first end of said shaft assembly for isolating said expanding means, said inlet vessel having an inlet for coupling a liquid stream to be expander to said expanding means in a pre-selected clockwise flow path and an outlet for discharging the expanded liquid,
an induction motor/generator mounted to said shaft assembly adjacent said sealing means,
fluid pumping means mounted to said shaft assembly adjacent said motor/generator and said second end of said shaft assembly,
a isolating vessel connected between said sealing means and beyond said second end of said shaft assembly, said isolating vessel having a fluid inlet and outlet for the pumped fluid, said motor/generator being submerged in the fluid stream of said pumping means,
the isolating vessel having an inlet for coupling a fluid stream to said pumping means to flow in a pre-selected flow which is the opposite direction of the path for expanding the aforementioned fluid stream to an outlet,
and operating the induction generator as a motor for driving said pumping means and submerging said generator in the pumped fluid stream.

9) A high efficient compact assembly of a LNG-MR Expander comprising
a single shaft assembly having first and second ends for mounting at least a single, two phase submerged LNG turbine expander, and at least a single phase submerged MR expander and a power generator thereon in a pre-selected relationship on said shaft assembly,
a first sealing means mounted to said shaft assembly between said LNG turbine expander and said power generator for isolating said expander from said generator,
a second sealing means mounted to said shaft assembly between said MR expander and said power generator for isolating said expander from said generator,
a MR vessel having a MR inlet and a MR outlet for coupling a MR fluid stream into said MR expander and a MR outlet for said vessel in communication with the MR fluid discharged from said MR expander,
a coolant vessel coupled between said first and second sealing means and having a coolant inlet for coupling a pre-selected cooling fluid to said power generator and having a coolant outlet for discharging the coolant stream exposed to said generator, and
a LNG vessel coupled to said first sealing means and beyond the first end of said shaft assembly for isolating said LNG turbine from said generator, said LNG vessel having an LNG outlet and inlet for coupling a LNG fluid stream or combination fluid stream and vapor to said LNG Expander to be discharged from the vessel by said vessel outlet whereby the heat from said generator is completely separated from the LNG stream and MR stream whereby a high efficiency is achieved.

10) A high efficient compact assembly of a LNG-MR expander as defined in claim 9 wherein said LNG turbine expander comprises a plurality of two phase expanders arranged in two stages on said single shaft assembly.

11) A high efficient compact assembly of a LNG-MR expander as defined in claim 9 or 10 wherein said MR expander comprises a plurality of MR expander stages.

12) A compact assembly of a liquefied natural gas (LNG)-mixed hydrocarbon refrigerants (MR) comprises
a single shaft assembly having first and second ends for mounting a hydraulic turbine expansion means and an electrical power generator thereon between said ends, said shaft assembly being oriented in a substantial vertical position,
sealing means mounted to said single shaft assembly for separating the processing of the liquefied natural gas and the mixed refrigerants processing arranged at a pre-selected location intermediate the ends of said single shaft assembly,
a gas vessel housing having a gas inlet and gas outlet mounted between said sealing means and said first end of said single shaft assembly for enclosing and isolating said shaft thereby defining the volume for processing the natural gas in liquid and/or liquid-vapor form,
said housing enclosing at least a single two phase liquefied natural gas hydraulic turbine expander for the liquefied, cryogenic gas or gas-liquid steam coupled to said gas inlet of said gas vessel housing, said hydraulic turbine expander comprises a radial turbine runner means mounted to said shaft assembly to be rotatably responsive to said inlet gas stream coupled thereto for rotating said shaft,
the liquefied, cryogenic gas is caused to flow through the hydraulic turbines in an upwardly vertical direction through said turbine and providing the cryogenic liquids coupled thereto in two phases,
a gas vessel housing having a mixed hydrocarbon refrigerant inlet and outlet mounted between said sealing means and said second end of said single shaft assembly,
said refrigerant housing enclosing at least a single hydraulic turbine expander and an electrical power generator mounted on said shaft assembly in a pre-selected relationship with said inlet and outlet for the refrigerant housing and said power generator so as to move the mixed refrigerant through said turbine expander and across the electrical power generator to thereby cool said generator,
said power generator comprising an electrical induction generator mounted on said shaft to be rotatably responsive to the rotary movements imparted to said shaft upon the operation of said turbine means and in accordance with the speed thereof.
said hydraulic turbine means including thrust equalizing means mounted to said shaft adjacent said bearing means, said bearing means having an inner race mounted to said shaft and an outer race loosely mounted against said refrigerant housing to permit the shaft to move axially, bidirectionally, relative to said housing a pre-selected distance, the thrust loading is minimized by the combination of the thrust equalizing means and the opposite fluid flow directions of the fluids coupled to said gas inlet and said mixed refrigerants inlet of the respective housing thereby providing a higher hydraulic efficiency to said turbines,
the heat generated by said power generator is isolated from the liquefied natural gas stream by said sealing means whereby the process efficiency is improved.

13) A method of minimizing the thrust generated by hydraulic turbine expanders wherein a single shaft assembly mounts a liquefied natural gas, LNG, hydraulic turbine expander and a mixed refrigerant, MR, hydraulic turbine expander spaced on opposite sides of a sealing means mounted to the shaft assembly, a LNG vessel mounted on the shaft assembly between the sealing means and one end of the shaft assembly for enclosing the LNG turbine expander, the LNG vessel having an inlet for coupling a LNG stream into the vessel to be operative with the turbine expander and an outlet for discharging the expanded LNG stream whereby said turbine stream traverses a pre-selected clockwise flow path between the LNG vessel's inlet and outlet and exerts a thrust force on the shaft assembly in a first direction,
a MR vessel mounted on the shaft assembly between the opposite side of the sealing means from the LNG vessel and the opposite end of the shaft assembly from the LNG vessel for enclosing the MR turbine expander, the MR vessel having an inlet and outlet for coupling the MR fluid stream to the turbine expander and to traverse a flow path of the opposite clockwise path traversed by the LNG stream exerts a thrust force on the shaft assembly in a second direction opposed to said first direction whereby the thrust generated by the hydraulic turbine expanders on the shaft assembly is minimized without the need for installing a thrust equalizing device acting on the thrust forces.

14) A method of minimizing the thrust generated by hydraulic turbine expanders as defined in claim 13 including an electrical power generator mounted on said shaft assembly on the opposite side of said MR turbine expander from said opposite end of the shaft assembly and rotatably responsive to the rotary movements imparted to said shaft assembly,
second sealing means mounted to said shaft assembly between said MR turbine expander and said power generator, and a coolant vessel connected between said first and second sealing means for isolating said generator, said coolant vessel having a coolant inlet and outlet for coupling an inert coolant stream into said coolant vessel at a pre-selected pressure for cooling said generator, the coolant stream having a higher input pressure than the LNG stream and MR stream for balancing out the generated turbine expander thrust forces along with the opposite flow directions of the LNG and MR streams.
